(19) United States
(12) Patent Application Publication
(10) Pub. No.: US 2003/0178115 A1
(43) Pub. Date: Sep. 25, 2003

(54) Tire structure for a bicycle

(76) Inventor: Yu-Ren Liu, Changhua City (TW)

Correspondence Address: CHARLES E. BAXLEY, ESQUIRE, Hart, Baxley, Daniels & Holton, 5 Fl, 59 John St., New York, NY, 10038, US

(21) Appl. No.: 10/104,515

(22) Filed: Mar. 25, 2002

(51) Int. Cl. B60C 11/00; B60C 123/00

(52) U.S. Cl. 152/209.5; 152/209.11

(57) ABSTRACT

A tire structure for a bicycle includes a tire body having an outer periphery, and a tread integrally formed on the outer periphery of the tire body. The tread includes an inner layer having a first color, and an outer layer coated on the inner layer and having a second color different from the first color. The outer layer formed with a plurality of openings, thereby exposing the inner layer outward from the outer layer through the plurality of openings. In such a manner, the inner layer and the outer layer of the tread present at least two different colors, thereby increasing the aesthetic quality of the tire structure of the bicycle.

### BACKGROUND OF THE INVENTION

1. Field of the Invention

The present invention relates to a tire structure for a bicycle, and more particularly to a tire structure that may present at least two different colors, thereby increasing the aesthetic quality of the tire structure of the bicycle.

2. Description of the Related Art

A conventional tire for a bicycle is made of rubber that usually has a single color only, so that the tire of the bicycle lack variation of color, thereby decreasing the aesthetic quality of the tire during travel of the bicycle.

### SUMMARY OF THE INVENTION

The present invention has arisen to mitigate and/or obviate the disadvantage of the conventional tire for a bicycle.

The primary objective of the present invention is to provide a tire structure for a bicycle, wherein the inner layer and the outer layer of the tread of the tire structure may present at least two different colors, thereby greatly increasing the aesthetic quality of the tire structure of the bicycle.

In accordance with the present invention, there is provided a tire structure for a bicycle, comprising:

a tire body having an outer periphery; and

a tread integrally formed on the outer periphery of the tire body, the tread including an inner layer having a first color, and an outer layer coated on the inner layer and having a second color different from the first color, the outer layer formed with a plurality of openings, thereby exposing the inner layer outward from the outer layer through the plurality of openings.

The inner layer is formed with a plurality of lugs, and the outer layer is formed with a plurality of embosses each coated on a respective one of the lugs of the inner layer.

In accordance with one embodiment of the present invention, at least some of the embosses are formed with the plurality of openings, thereby in turn exposing some of the lugs of the inner layer outward from some of the embosses of the outer layer through the plurality of openings.

In accordance with another embodiment of the present invention, all of the embosses are formed with the plurality of openings, thereby exposing the lugs of the inner layer outward from all of the embosses of the outer layer through the plurality of openings.

In accordance with a further embodiment of the present invention, the lugs of the inner layer include at least two different colors.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a tire structure for a bicycle in accordance with a first embodiment of the present invention;

FIG. 2 is a cross-sectional view of the tire structure for a bicycle as shown in FIG. 1;

FIG. 3 is a cross-sectional view of the tire structure for a bicycle as shown in FIG. 1;

FIG. 4 is a cross-sectional view of a tire structure for a bicycle in accordance with a second embodiment of the present invention; and

FIG. 5 is a cross-sectional view of the tire structure for a bicycle in accordance with the second embodiment of the present invention.

### DETAILED DESCRIPTION OF THE INVENTION

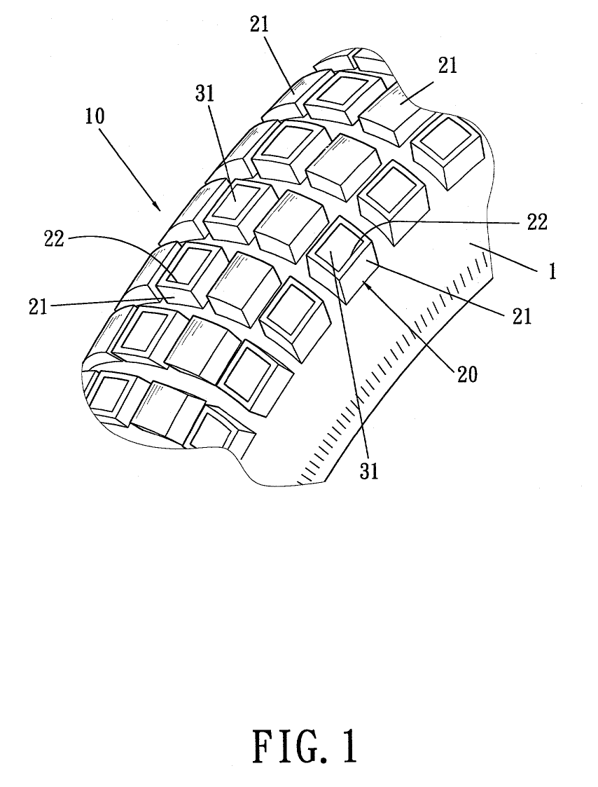

Referring to the drawings and initially to FIGS. 1-3, a tire structure for a bicycle in accordance with a first embodiment of the present invention comprises a tire body 1 having an outer periphery, and a tread 10 integrally formed on the outer periphery of the tire body 1.

The tread 10 includes an inner layer 30 having a color, and an outer layer 20 coated on the inner layer 30 and having a color different from that of the inner layer 20.

The inner layer 30 is formed with a plurality of lugs 31, and the outer layer 20 is formed with a plurality of embosses 21 each coated on a respective one of the lugs 31 of the inner layer 30.

Preferably, some of the embosses 21 are formed with openings 22 by a grinding process, thereby exposing some of the lugs 31 of the inner layer 30 outward from the respective embosses 21 of the outer layer 20 through the plurality of openings 22.

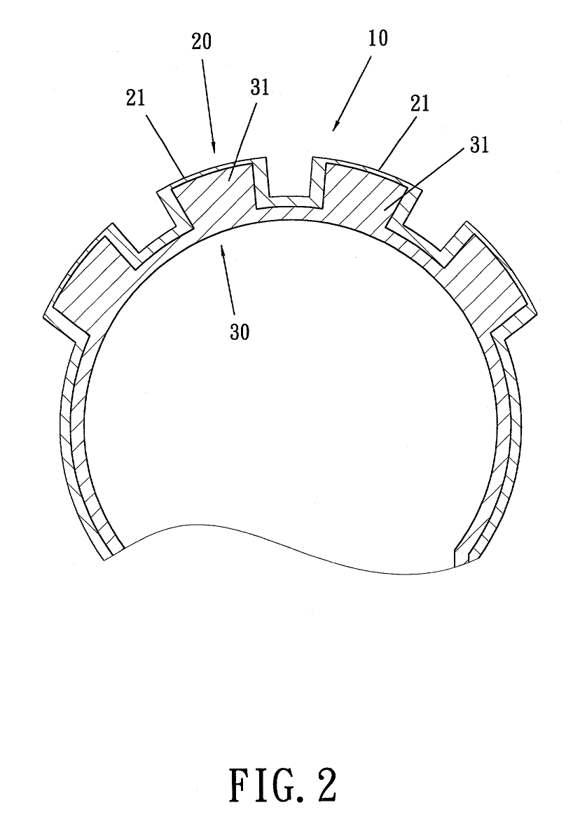

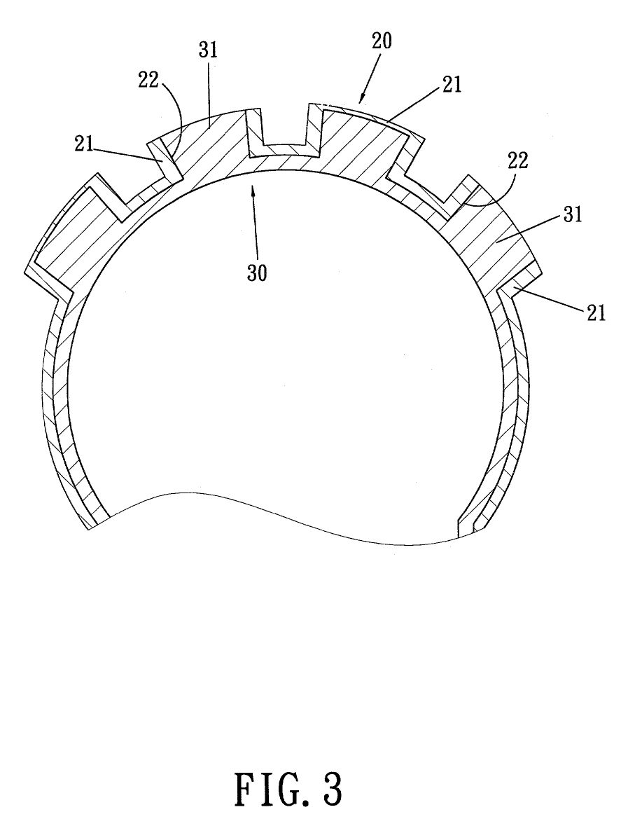

As shown in FIG. 2, the embosses 21 of the outer layer 20 are entirely coated on the lugs 31 of the inner layer 30 before the openings 22 are formed. As shown in FIG. 3, some of the embosses 21 of the outer layer 20 are flattened by the grinding process, to form the plurality of openings 22, thereby exposing some of the lugs 31 of the inner layer 30 outward from the respective embosses 21 of the outer layer 20 through the plurality of openings 22, such that the embosses 21 of the outer layer 20 and the lugs 31 of the inner layer 30 of the tread 10 of the tire structure may present two different colors.

Alternatively, not shown in the figure, all of the embosses 21 are formed with openings 22 by the grinding process, thereby exposing all of the lugs 31 of the inner layer 30 outward from all of the embosses 21 of the outer layer 20 through the plurality of openings 22.

By such an arrangement, the inner layer 30 and the outer layer 20 of the tread 10 of the tire structure may present at least two different colors, so as to enhance the variation of the colors, thereby greatly increasing the aesthetic quality of the tire structure of the bicycle during travel.

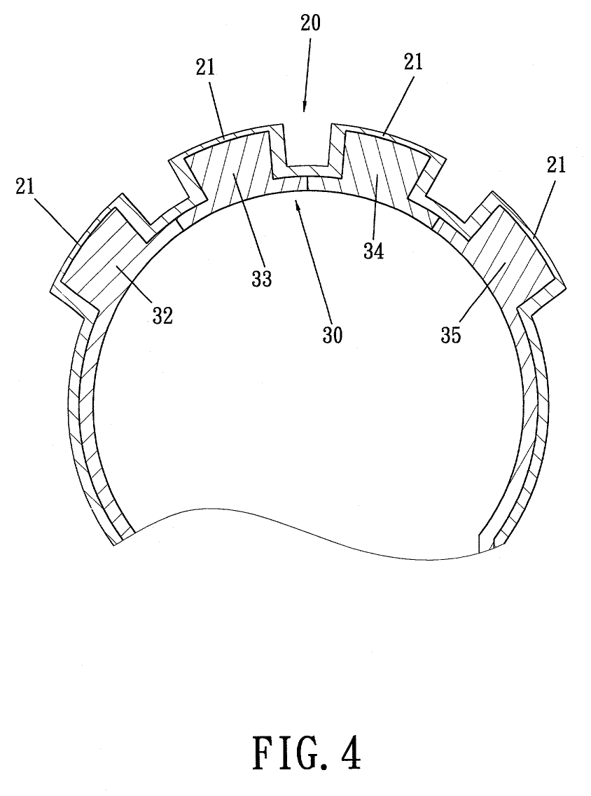

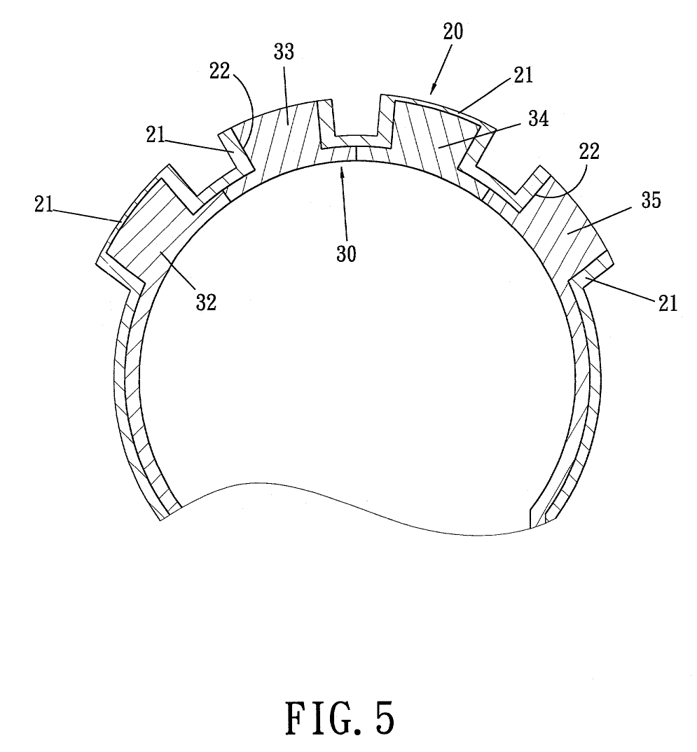

Referring to FIGS. 4 and 5, in accordance with a second embodiment of the present invention, the lugs 31 of the inner layer 30 include at least two different colors. Preferably, the inner layer 30 is formed with a plurality of first lugs 32 having a first color, a plurality of second lugs 33 having a second color, a plurality of third lugs 34 having a third color, and a plurality of fourth lugs 35 having a fourth color. As shown in FIG. 5, some of the embosses 21 of the outer layer 20 are flattened by the grinding process, to form the plurality of openings 22, thereby exposing the second lugs 33 and the fourth lugs 35 of the inner layer 30 outward from the respective embosses 21 of the outer layer 20 through the plurality of openings 22, so that the embosses 21 of the outer layer 20 and the second lugs 33 and the fourth lugs 35 of the inner layer 30 of the tread 10 of the tire structure may present three different colors.

By such an arrangement, the inner layer 30 and the outer layer 20 of the tread 10 of the tire structure may present at least three different colors, thereby greatly increasing the aesthetic quality of the tire structure of the bicycle during travel.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A tire structure for a bicycle, comprising:
a tire body (1) having an outer periphery; and
a tread (10) integrally formed on said outer periphery of said tire body (1), said tread (10) including an inner layer (30) having a first color, and an outer layer (20) coated on said inner layer (30) and having a second color different from said first color, said outer layer (20) formed with a plurality of openings (22), thereby exposing said inner layer (30) outward from said outer layer (20) through said plurality of openings (22).

2. The tire structure for a bicycle in accordance with claim 1, wherein said inner layer (30) is formed with a plurality of lugs (31), and said outer layer (20) is formed with a plurality of embosses (21) each coated on a respective one of said lugs (31) of said inner layer (30), at least some of said embosses (21) are formed with said plurality of openings (22), thereby exposing some of said lugs (31) 6f said inner layer (30) outward from some of said embosses (21) of said outer layer (20) through said plurality of openings (22).

3. The tire structure for a bicycle in accordance with claim 2, wherein all of said embosses (21) are formed with said plurality of openings (22), thereby exposing said lugs (31) of said inner layer (30) outward from all of said embosses (21) of said outer layer (20) through said plurality of openings (22).

4. The tire structure for a bicycle in accordance with claim 1, wherein said lugs (31) of said inner layer (30) include at least two different colors.
